(19) United States
(12) Patent Application Publication
(10) Pub. No.: US 2025/0365671 A1
(43) Pub. Date: Nov. 27, 2025

(54) GENERATION AND TRANSMISSION OF COMPRESSED IDENTITY OF RECEIVER DEVICE AND DETECTION AT RECEIVER DEVICE

(71) Applicant: HUAWEI TECHNOLOGIES CO., LTD., Shenzhen (CN)

(72) Inventors: Alberto Giuseppe Perotti, Segrate (IT); Branislav M. Popovic, Kista (SE); Fredrik Berggren, Kista (SE)

(73) Assignee: HUAWEI TECHNOLOGIES CO., LTD., Shenzhen (CN)

(21) Appl. No.: 19/296,792

(22) Filed: Aug. 11, 2025

Related U.S. Application Data
(63) Continuation of application No. PCT/EP2023/058153, filed on Mar. 29, 2023.

(51) Int. Cl. H04W 52/02; H04L 1/00; H04W 12/037

(52) U.S. Cl. CPC H04W 52/0235; H04L 1/0057; H04L 1/0071; H04W 12/037; H04W 52/0274

(57) ABSTRACT

A transmitter device and a receiver device are provided for signaling of a compressed identity of the receiver device in a communication system such as 3GPP new radio. The compressed identity is obtained from an identity of the receiver device by dividing a set of bits representing the ID into a first set of symbols comprising K number of symbols belonging to a Galois field, and mapping the first set of symbols based on an error correction code to obtain a second set of symbols belonging to the Galois field. Thereafter, the second set of symbols are interleaved based on a pseudo-random integer to obtain a set of interleaved symbols and a subset of interleaved symbols is selected among the set of interleaved symbols, the subset of interleaved symbols represents a compressed identity of the receiver device and comprises N number of symbols wherein N is less than K.

### CROSS-REFERENCE TO RELATED APPLICATIONS

This application is a continuation of International Application No. PCT/EP2023/058153, filed on Mar. 29, 2023, the disclosure of which is hereby incorporated by reference in its entirety.

### TECHNICAL FIELD

Embodiments of the present disclosure relate to a transmitter device and a receiver device for signaling a compressed identity of the receiver device in a communication system. Furthermore, embodiments of the present disclosure also relate to corresponding methods and a computer program.

### BACKGROUND

The 3^{rd} Generation Partnership Project (3GPP) is developing solutions to reduce the power consumption for certain User Equipment (UE) categories having limited energy sources, for example Internet-of-Things (IoT) sensors and actuators powered by non-rechargeable coin-size batteries, or wearable devices such as smart watches, rings, eHealth related and medical monitoring devices.

When there is no data traffic, most of the UE power is spent monitoring the downlink control channel for incoming data communication requests. In order to reduce the UE power consumption, the Discontinuous Reception (DRX) method has been introduced in 4G and 5G networks. DRX suspends UE monitoring of the control channel for a configured period of time by putting the UE in a sleep mode. With DRX, the power consumption depends on the length of the wake-up periods. To meet battery life requirements, long DRX cycles are useful. However, long DRX cycles would cause high latency for services with requirements of both long battery life and low latency.

In conventional solutions, the UE is equipped with an ultra-low-power wake-up receiver (WUR). The main UE transceiver (TRX) is switched off when there's no data to communicate. The WUR monitors a predefined set of time-frequency resources for presence of a UE-specific (or UE-group specific) wake-up signal WUS containing the identity of the UE to be woken up. When the WUS is detected, the WUR switches on the main TRX so as to resume normal data communication operations.

### SUMMARY

Embodiments of the present disclosure provide a solution which mitigates or solves the drawbacks and problems of conventional solutions.

According to a first aspect of the present disclosure, a transmitter device for a communication system is provided, the transmitter device being configured to:
divide a set of bits representing an identity of a receiver device into a first set of symbols comprising K number of symbols belonging to a Galois field;
map the first set of symbols based on an error correction code to obtain a second set of symbols belonging to the Galois field;
interleave the second set of symbols based on a pseudo-random integer to obtain a set of interleaved symbols;
select a subset of interleaved symbols among the set of interleaved symbols, the subset of interleaved symbols representing a compressed identity of the receiver device and comprising N number of symbols where N is less than K; and
transmit a first communication signal to the receiver device, the first communication signal indicating the subset of interleaved symbols.

An advantage of the transmitter device according to the first aspect is that receiver device identification requires transmission of only N less than K symbols, where N can be configured in the receiver device based on the expected channel quality. Moreover, interleaving the second set of symbols based on the pseudo-random integer and subsequently selecting a subset of interleaved symbols provides a convenient and flexible way to select a subset of symbols based on a pseudo-random integer.

In an implementation form of a transmitter device according to the first aspect, the second set of symbols is a codeword obtained according to a Galois field polynomial having a degree of at least K−1.

An advantage with this implementation form is that two different receiver device identities produce sets of symbols that collide in no more positions than the degree of the Galois field polynomial. That property is convenient because, by having a low number of colliding coordinates, the probability that any two different identities produce the same subset of symbols after selection of a subset of symbols remains low.

In an implementation form of a transmitter device according to the first aspect, the second set of symbols forms a codeword of a Reed-Solomon code.

An advantage with this implementation form is that the Reed-Solomon codes are maximum distance separable (MDS) codes, i.e., they have the maximum possible minimum Hamming distance between any two codewords for any given code rate and codeword length. Any two different receiver device identities produce codewords that collide in no more positions than the codeword length minus the minimum distance. It follows that the number of colliding codeword coordinates is minimum with MDS codes.

In an implementation form of a transmitter device according to the first aspect, the first communication signal further indicates the pseudo-random integer.

An advantage with this implementation form is that there is no need to have a pseudo-random integer generator in the receiver device, as the pseudo-random integer is obtained directly from the received first communication signal.

In an implementation form of a transmitter device according to the first aspect, the pseudo-random integer is computed based on an initial seed and a linear congruential generator or a pseudo-random Gold sequence generator.

An advantage with this implementation form is that the pseudo-random integer may be generated by few processor operations or by low complexity digital circuits.

In an implementation form of a transmitter device according to the first aspect, the transmitter device is configured to:
transmit a second communication signal to the receiver device, the second communication signal indicating the initial seed for computing the pseudo-random integer.

An advantage with this implementation form is that the random number generators in the transmitter device and receiver device(s) are synchronized based on the second communication signal. With synchronized random number generators, it is no longer necessary to indicate the random integer within the first communication signal, thereby saving channel resources.

In an implementation form of a transmitter device according to the first aspect, the second communication signal is transmitted over an encrypted communication channel.

An advantage with this implementation form is that the random number generator's initial seed remains confidential between the transmitter device and the receiver device(s). Eavesdroppers would not therefore be able to obtain the initial seed for generating the pseudo-random integer.

In an implementation form of a transmitter device according to the first aspect, the transmitter device is configured to:
select the subset of interleaved symbols based on a predefined selection rule.

An advantage with this implementation form is that as the selection rule is predefined, the transmitter device and the receiver device(s) do not need to indicate to each other the selection rule thereby reducing overhead in the system.

In an implementation form of a transmitter device according to the first aspect, the predefined selection rule indicates any of: selecting the N first symbols or the N last symbols of the set of interleaved symbols.

An advantage with this implementation form is that the predefined selection rule is simple and easily implemented.

In an implementation form of a transmitter device according to the first aspect, the first communication signal is a wake-up signal.

An advantage with this implementation form is that the first communication signal can be conveniently used to wake up a main transceiver in a wireless network serving ultra-low-power terminals equipped with wake-up receivers.

According to a second aspect of the present disclosure, a receiver device for a communication system is provided, the receiver device being configured to:
receive a first communication signal from a transmitter device, the first communication signal indicating a first subset of interleaved symbols representing a first compressed identity of the receiver device;
divide a set of bits representing an identity of a receiver device into a first set of symbols comprising K number of symbols belonging to a Galois field;
map the first set of symbols based on an error correction code to obtain a second set of symbols belonging to the Galois field;
interleave the second set of symbols based on a pseudo-random integer to obtain a set of interleaved symbols;
select a second subset of interleaved symbols among the set of interleaved symbols, the second subset of interleaved symbols representing a second compressed identity of the receiver device and comprising N number of symbols where N is less than K; and generate a wake-up command when the first subset of interleaved symbols and second subset of interleaved symbols are the same.

It may be noted that the configuration steps of the receiver device according to the second aspect may be performed at least once. However, the configuration steps of: interleave the second set of symbols based on a pseudo-random integer to obtain a set of interleaved symbols; and select a second subset of interleaved symbols among the set of interleaved symbols, the second subset of interleaved symbols representing a second compressed identity of the receiver device and comprising N number of symbols where N is less than K; may be performed for each time a first communication signal is received and processed by the receiver device.

An advantage of the receiver device according to the second aspect is that the identification of the receiver device requires transmission of only N less than K symbols, where N can be configured in the receiver device based on the expected channel quality. Moreover, interleaving the second set of symbols based on the pseudo-random integer and subsequently selecting a subset of interleaved symbols provides a convenient and flexible way to select a subset of symbols based on a pseudo-random integer.

In an implementation form of a receiver device according to the second aspect, the second set of symbols is a codeword obtained according to a Galois field polynomial having a degree of at least K−1.

An advantage with this implementation form is that two different receiver device identities produce sets of symbols that collide in no more positions than the degree of the Galois field polynomial. That property is convenient because, by having a low number of colliding coordinates, the probability that any two different identities produce the same subset of symbols after selection of a subset of symbols remains low.

In an implementation form of a receiver device according to the second aspect, the second set of symbols forms a codeword of a Reed-Solomon code.

An advantage with this implementation form is that the Reed-Solomon codes are MDS codes, i.e., they have the maximum possible minimum Hamming distance between any two codewords for any given code rate and codeword length. Any two different receiver device identities produce codewords that collide in no more positions than the codeword length minus the minimum distance. It follows that the number of colliding codeword coordinates is minimum with MDS codes.

In an implementation form of a receiver device according to the second aspect, the first communication signal further indicates the pseudo-random integer.

An advantage with this implementation form is that there is no need to have a pseudo-random integer generator in the receiver device, as the pseudo-random integer is obtained directly from the received first communication signal.

In an implementation form of a receiver device according to the second aspect, the receiver device is configured to:
receive a second communication signal from the transmitter device, the second communication signal indicating an initial seed for computing the pseudo-random integer; and
compute the pseudo-random integer based on the initial seed.

An advantage with this implementation form is that the random number generators in the transmitter device and receiver device(s) are synchronized based on the second communication signal. With synchronized random number generators, it is no longer necessary to indicate the random integer within the first communication signal, thereby saving channel resources.

In an implementation form of a receiver device according to the second aspect, the pseudo-random integer is computed based on the initial seed and a linear congruential generator or a pseudo-random Gold sequence generator.

An advantage with this implementation form is that the pseudo-random integer may be generated by few processor operations or by low complexity digital circuits.

In an implementation form of a receiver device according to the second aspect, the second communication signal is received over an encrypted communication channel.

An advantage with this implementation form is that the random number generator's initial seed remains confidential between the transmitter device and the receiver device(s). Eavesdroppers would not therefore be able to obtain the initial seed for generating the pseudo-random integer.

In an implementation form of a receiver device according to the second aspect, the receiver device is configured to:
select the second subset of interleaved symbols based on a predefined selection rule.

An advantage with this implementation form is that as the selection rule is predefined, the transmitter device and the receiver device(s) do not need to indicate to each other the selection rule thereby reducing overhead in the system.

In an implementation form of a receiver device according to the second aspect, the predefined selection rule indicates any of: selecting the N first symbols or the N last symbols of the set of interleaved symbols.

An advantage with this implementation form is that the predefined selection rule is simple and easily implemented.

In an implementation form of a receiver device according to the second aspect, the first communication signal is a wake-up signal.

An advantage with this implementation form is that the first communication signal can be conveniently used to wake up a main transceiver in a wireless network serving ultra-low-power terminals equipped with wake-up receivers.

According to a third aspect of the present disclosure, a method for a transmitter device is provided, the method comprises:
dividing a set of bits representing an identity of a receiver device into a first set of symbols comprising K number of symbols belonging to a Galois field;
mapping the first set of symbols based on an error correction code to obtain a second set of symbols belonging to the Galois field;
interleaving the second set of symbols based on a pseudo-random integer to obtain a set of interleaved symbols;
selecting a subset of interleaved symbols among the set of interleaved symbols, the subset of interleaved symbols representing a compressed identity of the receiver device and comprising N number of symbols where N is less than K; and
transmitting a first communication signal to the receiver device, the first communication signal indicating the subset of interleaved symbols.

The method according to the third aspect can be extended into implementation forms corresponding to the implementation forms of the transmitter device according to the first aspect. Hence, an implementation form of the method comprises the feature(s) of the corresponding implementation form of the transmitter device.

The advantages of the methods according to the third aspect are the same as those for the corresponding implementation forms of the transmitter device according to the first aspect.

According to a fourth aspect of the present disclosure, a method for a receiver device is provided, the method comprises
receiving a first communication signal from a transmitter device, the first communication signal indicating a first subset of interleaved symbols representing a first compressed identity of the receiver device;
dividing a set of bits representing an identity of a receiver device into a first set of symbols comprising K number of symbols belonging to a Galois field;
mapping the first set of symbols based on an error correction code to obtain a second set of symbols belonging to the Galois field;
interleaving the second set of symbols based on a pseudo-random integer to obtain a set of interleaved symbols;
selecting a second subset of interleaved symbols among the set of interleaved symbols, the second subset of interleaved symbols representing a second compressed identity of the receiver device and comprising N number of symbols where N is less than K; and generating a wake-up command when the first subset of interleaved symbols and second subset of interleaved symbols are the same.

The method according to the fourth aspect can be extended into implementation forms corresponding to the implementation forms of the receiver device according to the second aspect. Hence, an implementation form of the method comprises the feature(s) of the corresponding implementation form of the receiver device.

The advantages of the methods according to the fourth aspect are the same as those for the corresponding implementation forms of the receiver device according to the second aspect.

Embodiments of the present disclosure also relate to a computer program, characterized in program code, which when run by at least one processor causes the at least one processor to execute any method according to embodiments of the present disclosure. Further, embodiments of the present disclosure also relate to a computer program product comprising a computer readable medium and the mentioned computer program, wherein the computer program is included in the computer readable medium, and may comprises one or more from the group of: read-only memory (ROM), programmable ROM (PROM), erasable PROM (EPROM), flash memory, electrically erasable PROM (EEPROM), hard disk drive, etc.

Further applications and advantages of embodiments of the present disclosure will be apparent from the following detailed description.

### BRIEF DESCRIPTION OF THE DRAWINGS

The appended drawings are intended to clarify and explain different embodiments of the present disclosure, in which:

FIG. 1 shows a transmitter device according to an embodiment of the present disclosure;

FIG. 2 shows a flow chart of a method for a transmitter device according to an embodiment of the present disclosure;

FIG. 3 shows a receiver device according to an embodiment of the present disclosure;

FIG. 4 shows a flow chart of a method for a receiver device according to an embodiment of the present disclosure;

FIG. 5 shows a communication system according to an embodiment of the present disclosure;

FIG. 6 shows a wake-up frame with Time-Division Multiplexed (TDM) WUSs;

FIG. 7(a) and FIG. 7(b) are a block scheme of 7(a) the WUS transmitter and 7(b) WUS receiver according to the first embodiment of the present disclosure;

FIG. 8(a) and FIG. 8(b) are a block scheme of 8(a) the WUS transmitter and 8(b) WUS receiver according to the second embodiment of the present disclosure;

FIG. 9 shows mapping a UE identity to the coefficients of a Galois field polynomial of degree K-1;

FIG. 10 illustrates two main signaling aspects according to embodiments of the present disclosure;

FIG. 11 illustrates the RG seed distribution procedure;

FIG. 12 illustrates static WUS parameter assignment in a WU frame; and

FIG. 13 shows performance of the disclosed solution according to the first and second embodiments compared to conventional solutions.

### DETAILED DESCRIPTION

3GPP is studying whether to introduce a downlink Wake-Up Signal (WUS) for UEs equipped with an ultra-low power Wake-Up Receiver (WUR). In these UEs, the main transceiver (TRX) would be switched off most of the time. The WUR would monitor a predefined set of time-frequency resources for presence of a UE-specific or UE-group specific WUS. When the WUS is detected, the WUR switches on the main UE transceiver (TRX) so as to resume control channel monitoring and perform data communication.

Transmission of the WUS in the same time-frequency resources as the legacy New Radio (NR) physical channels is a convenient option. However, it implies exclusive permanent allocation of time-frequency resources for WUS transmission, thereby leaving less resource remaining for data transmission. It is therefore convenient to find WUS solutions with contained time-frequency footprint so as to minimize the impact on the legacy NR signal. In the same time, a good WUS must be aimed at minimizing the probability that the intended UE fails to detect its own ID in the received WUS, a.k.a. Missed Detection (MD) probability, and the probability that the other (unintended) UEs mistakenly detect their own IDs in the received WUS signal, a.k.a. False Alarm (FA) probability.

The information-theoretic framework of Identification via Channels (IvC) refers to a communication paradigm wherein a receiver is only interested in testing whether a particular identification message or signature was sent, instead of producing an accurate replica of the whole transmitted message at the receiver output as done in conventional communications systems. The number of identifiers (IDs) that can be reliably delivered grows double-exponentially with the codeword length. That is a much larger number of messages compared to the single-exponential growth one would have with conventional communications. Here, “reliably delivered” may mean “received with arbitrarily low probability of false alarm and missed identification”.

Conventionally, the transmitter maps an identification message m=(b₀, . . . , b_{B-1}) of length B bits to a sequence z=[z₀, . . . , Z_{K-1}] of length K symbols, where each symbol in the sequence is obtained by mapping a r-bit word from m to a symbol in the Galois Field GF(2^{r}). Thus, the sequence length is K=[B/r]. The transmitter encodes the sequence z using an (L, K) Reed-Solomon code over GF(2^{r}), where L is the RS codeword length in symbols: L=2^{r}−1. We denote the RS codeword as c=[c₀, . . . , C_{L-1}]. The transmitter further generates a random integer u between 0 and L−1 according to a uniform probability distribution. The random integer u and the codeword's u^{th} symbol cᵤ are concatenated so as to obtain the identification string [u, cᵤ] of length n=[log₂L]+r=2r bits. The string [u, cᵤ] is mapped to a codeword of a transmission code with input word length k_{ECC}=2r bits and codeword length n_{ECC} and then transmitted over a noisy channel.

The choice of the code for encoding the identification message m is crucial for achieving good identification performance as its minimum distance dₘᵢₙ directly determines the probability that two different identification messages m and m′ collide, that is, that m and m′ are mapped to the same identification string [u, cᵤ]. For a given codeword length L and minimum distance dₘᵢₙ, any two different codewords coincide in at most L−dₘᵢₙ coordinates. A collision occurs when the uniform random number u points to one of those L−dₘᵢₙ or less coordinates, therefore we obtain:

$${p}_{C O L} \leq \frac{L - {d}_{min}}{L} . \qquad ( 1 )$$

It follows that codes with large minimum distance have lower collision probability. Among linear codes, Reed-Solomon codes are those that have the largest possible minimum distance for any given codeword length L and message length K: dₘᵢₙ=L−K+1. These codes are called Maximum Distance Separable (MDS) codes in the coding theory literature. From Eq. (1), the RS codes' collision probability obeys the following inequality:

$${p}_{C O L}^{( R S )} \leq \frac{K - 1}{L} . \qquad ( 2 )$$

The right-hand side of Eq. (2) is the worst-case collision probability. It is obtained when messages m and m′ produce two corresponding codewords c and c′ with exactly K−1different symbols. However, for randomly selected messages m and m′, the Hamming distance between their corresponding codewords c and c′ is typically larger than dₘᵢₙ, therefore the number of coinciding coordinates is less than L−dₘᵢₙ and the collision probability is less than the right-hand side of Eq. (2). A relevant feature of the above transmission scheme is the average collision probability, which can be approximately evaluated by noting that, for randomly selected message m, the u^{th} codeword symbol is uniformly distributed over GF(2^{r}):

$$\begin{matrix}P ( {c}_{u} = s ) ≃ {2}^{- r} , & ∀ s ∈ G F ( {2}^{r} ) , u = 0 , … , L - 1.\end{matrix} \qquad ( 3 )$$

where P(A) denotes the probability of a given event A. Based on Eq. (3), we obtain the following average collision probability between two randomly and independently selected messages m and m′:

$$\begin{matrix}{p}_{COL} = {\sum }_{s ∈ GF ( {2}^{r} )} P ( {c}_{u} = s , {c}_{u}^{′} = s ) \\ = {\sum }_{s ∈ GF ( {2}^{r} )} P ( {c}_{u} = s ) P ( {c}_{u}^{′} = s ) = {2}^{- r}\end{matrix} \qquad ( 4 )$$

where

$${c}_{u}^{′}$$

is the u^{th} symbol of the codeword

$${c}^{′} = [ {c}_{0}^{′} , … , {c}_{L - 1}^{′} ]$$

that has been obtained by encoding message m′. The second line of Eq. (4) follows from the observation that, as m and m′ are independently selected, the symbols in their corresponding codewords

$$c = [ {c}_{0} , … , {c}_{L - 1} ] and {c}^{′} = [ {c}_{0}^{′} , … , {c}_{L - 1}^{′} ]$$

are statistically independent.

The receiver encodes its own identifier using the same (L,K) RS encoder as the transmitter so as to obtain its own ID codeword

$${c}^{′} [ {c}_{0}^{′} , … , {c}_{L - 1}^{′} ] .$$

The receiver obtains a possibly corrupted version ũ of the random integer u from the received signal, and compares the ũ^{th} symbol

$${c}_{\tilde{u}}^{′}$$

of its own ID codeword with the received coded symbol \tilde{c}ᵤ, where \tilde{c}ᵤ is a possibly corrupted version of the transmitted symbol cᵤ. If the two symbols match, the receiver declares that it has detected its own ID in the received signal.

The above transmission scheme is prone to failure events, namely FA and MD. The corresponding probabilities are defined as follows:
MD probability, denoted as p_{MD}, and defined as the probability that a receiver fails to detect its own ID in the received signal. As noise corrupts the received signal, the decoder may fail to detect its own ID in the received signal.
FA probability, denoted as p_{FA}, defined as the probability that a given receiver mistakenly detects its own ID in the received signal. As only one among N number of ID coded symbols is transmitted, the decoder may mistakenly detect its own ID when another ID was actually transmitted. It is assumed that the receiver is attempting to decode a WUS in all slots, regardless of the received signal power. There is no minimum-power threshold below which WUS decoding is skipped.

By noting that, for a large class of practically relevant channel models, the corrupted u^{th} codeword symbol cy remains uniformly distributed over GF(2^{r}), that is:

$$P ( {\tilde{c}}_{u} = s ) = {2}^{- r} , ∀ s ∈ GF ( {2}^{r} ) , u = 0 , … , L - 1 , \qquad ( 5 )$$

the FA probability can be computed in a similar way as the collision probability in Eq. (4):

$$\begin{matrix}{p}_{FA} = P ( {\tilde{c}}_{u} = {c}_{\tilde{u}}^{′} ) = {\sum }_{s ∈ GF ( {2}^{r} )} P ( {\tilde{c}}_{u} = s , {c}_{\tilde{u}}^{′} = s ) \\ = {\sum }_{s ∈ GF ( {2}^{r} )} P ( {\tilde{c}}_{u} = s ) P ( {c}_{\tilde{u}}^{′} = s ) = {2}^{- r}\end{matrix} \qquad ( 6 )$$

where the last equality follows from Eq. (5).

Thus, the FA probability does not depend on the quality of the received signal—it only depends on the size of the ID encoder symbol alphabet. Therefore, embodiments of the present disclosure herein disclosed provides solutions for transmission of compressed IDs which e.g., may be used in WU signal applications. The present solution has significantly better FA probability than conventional solutions, similar or better MD probability and uses the same or smaller amount of time-frequency resources. Moreover, embodiments of the present disclosure also solve the problem of vulnerability to spoofing attacks.

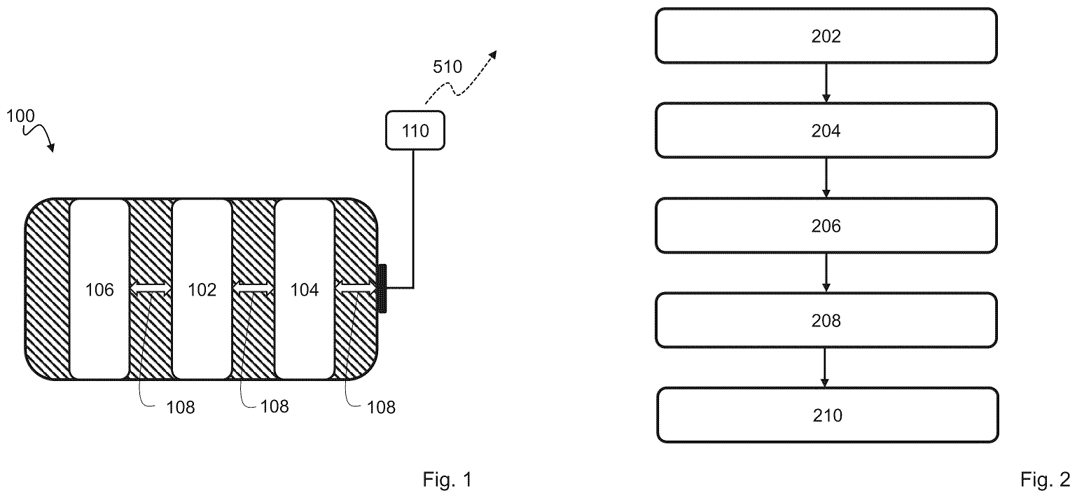

FIG. 1 shows a transmitter device 100 according to an embodiment of the present disclosure. In the embodiment shown in FIG. 1, the transmitter device 100 comprises a processor 102, a transceiver 104 and a memory 106. The processor 102 is coupled to the transceiver 104 and the memory 106 by communication means 108 known in the art. The transmitter device 100 may be configured for wireless and/or wired communications in a communication system. The wireless communication capability may be provided with an antenna or antenna array 110 coupled to the transceiver 104, while the wired communication capability may be provided with a wired communication interface 112 e.g., coupled to the transceiver 104.

The processor 102 may be referred to as one or more general-purpose central processing units (CPUs), one or more digital signal processors (DSPs), one or more application-specific integrated circuits (ASICs), one or more field programmable gate arrays (FPGAs), one or more programmable logic devices, one or more discrete gates, one or more transistor logic devices, one or more discrete hardware components, or one or more chipsets. The memory 106 may be a read-only memory, a random-access memory (RAM), or a non-volatile RAM (NVRAM). The transceiver 304 may be a transceiver circuit, a power controller, or an interface providing capability to communicate with other communication modules or communication devices, such as network nodes and network servers. The transceiver 104, memory 106 and/or processor 102 may be implemented in separate chipsets or may be implemented in a common chipset.

That the transmitter device 100 is configured to perform certain actions can in this disclosure be understood to mean that the transmitter device 100 comprises suitable means, such as e.g., the processor 102 and the transceiver 104, configured to perform the actions.

According to embodiments of the present disclosure the transmitter device 100 is configured to divide a set of bits representing an identity of a receiver device 300 into a first set of symbols comprising K number of symbols belonging to a Galois field. The transmitter device 100 is further configured to map the first set of symbols based on an error correction code to obtain a second set of symbols belonging to the Galois field. The transmitter device 100 is further configured to interleave the second set of symbols based on a pseudo-random integer to obtain a set of interleaved symbols. The transmitter device 100 is further configured to select a subset of interleaved symbols among the set of interleaved symbols, the subset of interleaved symbols representing a compressed identity of the receiver device 300 and comprising N number of symbols where N is less than K. The transmitter device 100 is further configured to transmit a first communication signal 510 to the receiver device 300, the first communication signal 510 indicating the subset of interleaved symbols.

Furthermore, in an embodiment of the present disclosure, the transmitter device 100 for a communication system 500 comprises a processor configured to: divide a set of bits representing an identity of a receiver device 300 into a first set of symbols comprising K number of symbols belonging to a Galois field; map the first set of symbols based on an error correction code to obtain a second set of symbols belonging to the Galois field; interleave the second set of symbols based on a pseudo-random integer to obtain a set of interleaved symbols; and select a subset of interleaved symbols among the set of interleaved symbols, the subset of interleaved symbols representing a compressed identity of the receiver device 300 and comprising N number of symbols where N is less than K. The transmitter device 100 comprises a transceiver configured to transmit a first communication signal 510 to the receiver device 300, the first communication signal 510 indicating the subset of interleaved symbols.

Moreover, in yet another embodiment of the present disclosure, the transmitter device 100 for a communication system 500 comprises a processor and a memory having computer readable instructions stored thereon which, when executed by the processor, cause the processor to: divide a set of bits representing an identity of a receiver device 300 into a first set of symbols comprising K number of symbols belonging to a Galois field; map the first set of symbols based on an error correction code to obtain a second set of symbols belonging to the Galois field; interleave the second set of symbols based on a pseudo-random integer to obtain a set of interleaved symbols; select a subset of interleaved symbols among the set of interleaved symbols, the subset of interleaved symbols representing a compressed identity of the receiver device 300 and comprising N number of symbols where N is less than K; and transmit a first communication signal 510 to the receiver device 300, the first communication signal 510 indicating the subset of interleaved symbols.

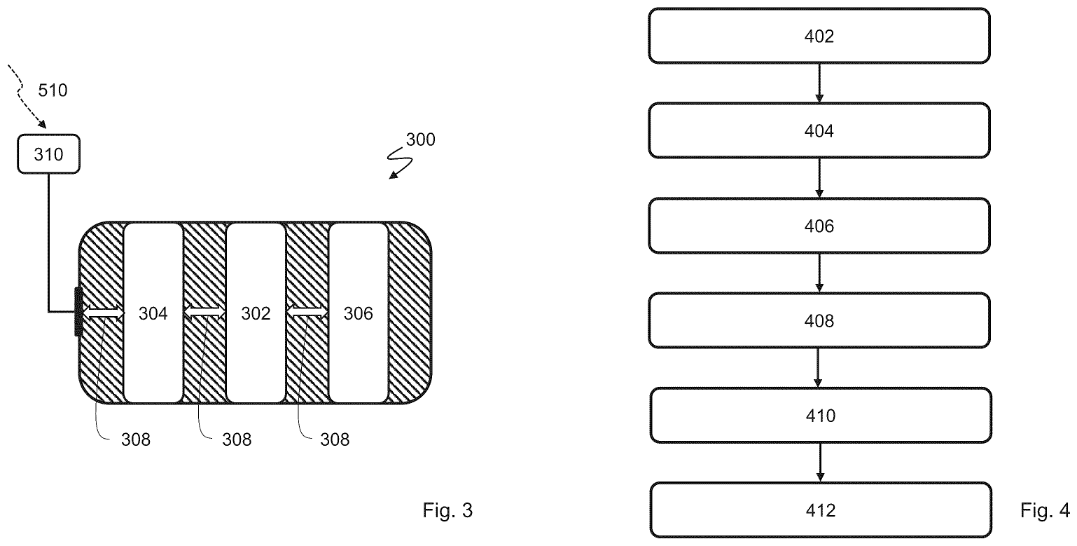

FIG. 2 shows a flow chart of a corresponding method 200 which may be executed in a transmitter device 100, such as the one shown in FIG. 1. The method 200 comprises dividing 202 a set of bits representing an identity of a receiver device 300 into a first set of symbols comprising K number of symbols belonging to a Galois field. The method 200 further comprises mapping 204 the first set of symbols based on an error correction code to obtain a second set of symbols belonging to the Galois field. The method 200 further comprises interleaving 206 the second set of symbols based on a pseudo-random integer to obtain a set of interleaved symbols. The method 200 further comprises selecting 208 a subset of interleaved symbols among the set of interleaved symbols, the subset of interleaved symbols representing a compressed identity of the receiver device 300 and comprising N number of symbols where N is less than K. The method 200 further comprises transmitting 210 a first communication signal 510 to the receiver device 300, the first communication signal 510 indicating the subset of interleaved symbols.

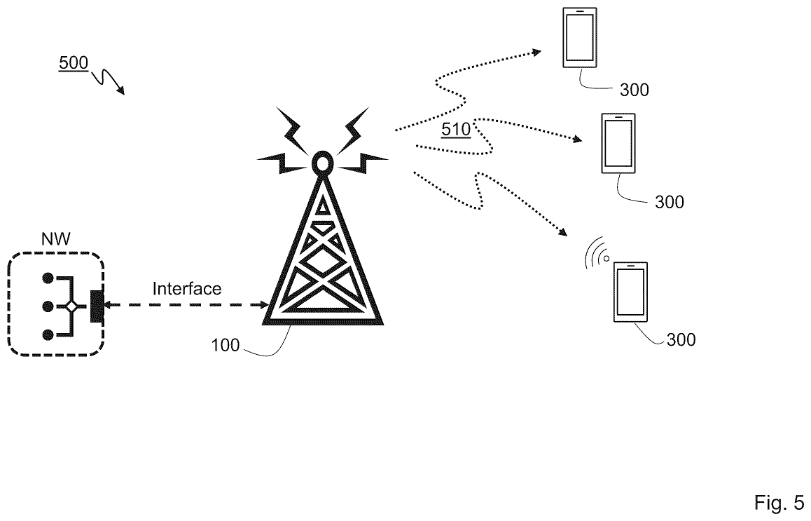

FIG. 3 shows a receiver device 300 according to an embodiment of the present disclosure. In the embodiment shown in FIG. 3, the receiver device 300 comprises a processor 302, a transceiver 304 and a memory 306. The processor 302 is coupled to the transceiver 304 and the memory 306 by communication means 308 known in the art. The receiver device 300 further comprises an antenna or antenna array 310 coupled to the transceiver 304, which means that the receiver device 300 is configured for wireless communications in a communication system.

The processor 302 may be referred to as one or more general-purpose CPUs, one or more DSPs, one or more ASICs, one or more FPGAs, one or more programmable logic devices, one or more discrete gates, one or more transistor logic devices, one or more discrete hardware components, one or more chipsets. The memory 306 may be a read-only memory, a RAM, or a NVRAM. The transceiver 104 may be a transceiver circuit, a power controller, or an interface providing capability to communicate with other communication modules or communication devices. The transceiver 304, the memory 306 and/or the processor 302 may be implemented in separate chipsets or may be implemented in a common chipset.

That the receiver device 300 is configured to perform certain actions can in this disclosure be understood to mean that the receiver device 300 comprises suitable means, such as e.g., the processor 302 and the transceiver 304, configured to perform the actions.

According to embodiments of the present disclosure, the receiver device 300 is configured to receive a first communication signal 510 from a transmitter device 100, the first communication signal 510 indicating a first subset of interleaved symbols representing a first compressed identity of the receiver device 300. The receiver device 300 is further configured to divide a set of bits representing an identity of a receiver device 300 into a first set of symbols comprising K number of symbols belonging to a Galois field. The receiver device 300 is further configured to map the first set of symbols based on an error correction code to obtain a second set of symbols belonging to the Galois field. The receiver device 300 is further configured to interleave the second set of symbols based on a pseudo-random integer to obtain a set of interleaved symbols. The receiver device 300 is further configured to select a second subset of interleaved symbols among the set of interleaved symbols, the second subset of interleaved symbols representing a second compressed identity of the receiver device 300 and comprising N number of symbols where N is less than K. The receiver device 300 is further configured to generate a wake-up command when the first subset of interleaved symbols and second subset of interleaved symbols are the same.

Furthermore, in an embodiment of the present disclosure, the receiver device 300 for a communication system 500 comprises a transceiver configured to receive a first communication signal 510 from a transmitter device 100, the first communication signal 510 indicating a first subset of interleaved symbols representing a first compressed identity of the receiver device 300. The receiver device 300 comprises a processor configured to: divide a set of bits representing an identity of a receiver device 300 into a first set of symbols comprising K number of symbols belonging to a Galois field; map the first set of symbols based on an error correction code to obtain a second set of symbols belonging to the Galois field; interleave the second set of symbols based on a pseudo-random integer to obtain a set of interleaved symbols; select a second subset of interleaved symbols among the set of interleaved symbols, the second subset of interleaved symbols representing a second compressed identity of the receiver device 300 and comprising N number of symbols where N is less than K; and generate a wake-up command when the first subset of interleaved symbols and second subset of interleaved symbols are the same.

Moreover, in yet another embodiment of the present disclosure, the receiver device 300 for a communication system 500 comprises a processor and a memory having computer readable instructions stored thereon which, when executed by the processor, cause the processor to: receive a first communication signal 510 from a transmitter device 100, the first communication signal 510 indicating a first subset of interleaved symbols representing a first compressed identity of the receiver device 300; divide a set of bits representing an identity of a receiver device 300 into a first set of symbols comprising K number of symbols belonging to a Galois field; map the first set of symbols based on an error correction code to obtain a second set of symbols belonging to the Galois field; interleave the second set of symbols based on a pseudo-random integer to obtain a set of interleaved symbols; select a second subset of interleaved symbols among the set of interleaved symbols, the second subset of interleaved symbols representing a second compressed identity of the receiver device 300 and comprising N number of symbols where N is less than K; and generate a wake-up command when the first subset of interleaved symbols and second subset of interleaved symbols are the same.

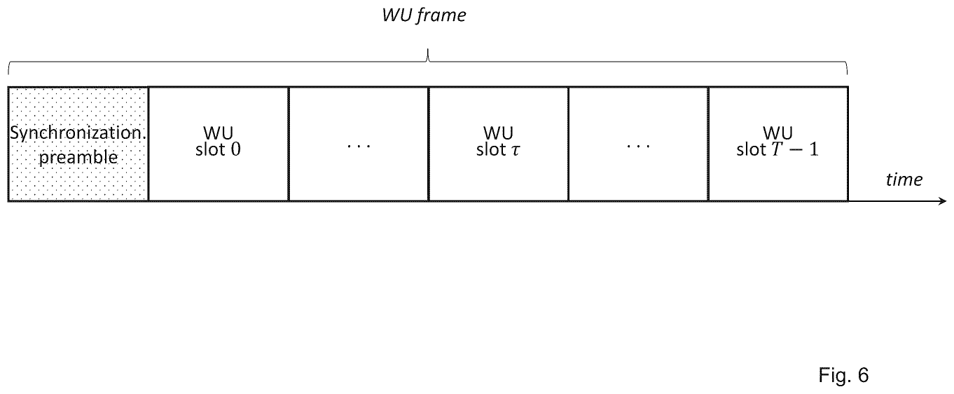

FIG. 4 shows a flow chart of a corresponding method 400 which may be executed in a receiver device 300, such as the one shown in FIG. 3. The method 400 comprises receiving 402 a first communication signal 510 from a transmitter device 100, the first communication signal 510 indicating a first subset of interleaved symbols representing a first compressed identity of the receiver device 300. The method 400 further comprises dividing 404 a set of bits representing an identity of a receiver device 300 into a first set of symbols comprising K number of symbols belonging to a Galois field. The method 400 further comprises mapping 406 the first set of symbols based on an error correction code to obtain a second set of symbols belonging to the Galois field. The method 400 further comprises interleaving 408 the second set of symbols based on a pseudo-random integer to obtain a set of interleaved symbols. The method 400 further comprises selecting 410 a second subset of interleaved symbols among the set of interleaved symbols, the second subset of interleaved symbols representing a second compressed identity of the receiver device 300 and comprising N number of symbols where N is less than K. The method 400 further comprises generating 412 a wake-up command when the first subset of interleaved symbols and second subset of interleaved symbols are the same.

In the following disclosure, further details related to embodiments of the present disclosure will be described in a 3GPP 5G context. Thus, 3GPP 5G terminology, definitions, expressions and system architecture will be used. More specifically, the disclosed examples and embodiments relate to wake up signaling schemes. It may however be noted that embodiments of the present disclosure are not limited thereto.

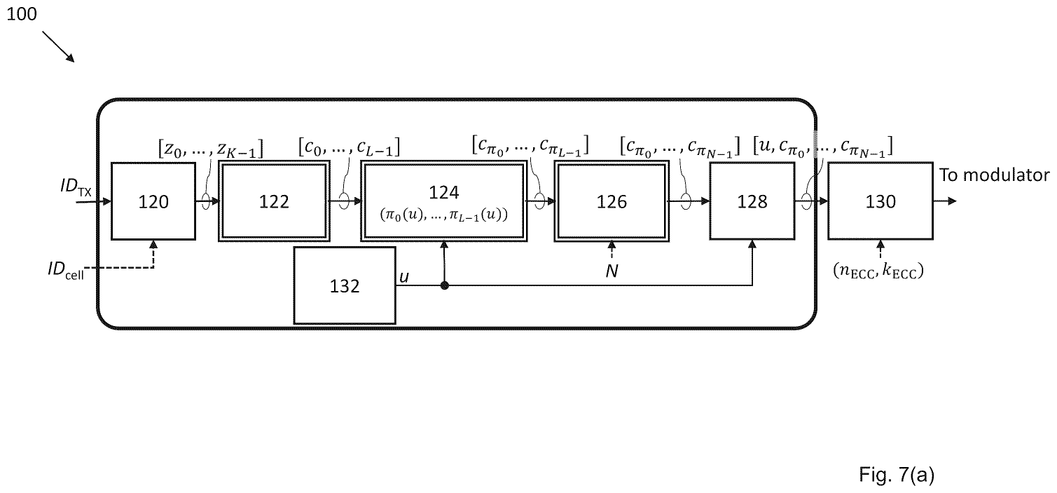

FIG. 5 shows a 3GPP communication system 500 such a new radio (NR). The communication system 500 in the disclosed example comprises a transmitter device 100 configured as a gNB and a plurality of receiver devices 300 configured as UEs. However, the communication system 500 may comprise any number of transmitter devices 100 and any number of receiver devices 300 without deviating from the scope of the present disclosure. The gNB is part of a radio access network (RAN) which may be connected to a core network NW via suitable communication interfaces. The RAN serves a plurality of UEs and each UE may in embodiments of the present disclosure be equipped with a main transceiver (TRX) and an ultra-low-power WUS receiver, respectively. In order to save energy, the main TRX is switched off whenever there is no data to transmit or receive. As soon as there is data for the UE, or the network expects data from the UE, the network transmitter, i.e., the gNB or any other network node, sends a wake-up signal to the UE carrying the encoded UE ID (ECC codeword), optionally combined with a cell ID in order to make the UE able to distinguish between WUSs generated by different cells. The ID may be a group ID for multiple UEs since the solution herein described is agnostic of whether the ID is for a single UE or for a group of UEs. Upon reception of the WUS with its own encoded UE ID, the WUS receiver sends a wake-up command to the main TRX in order to make the UE ready for subsequent data transmissions or receptions. Therefore, in embodiments of the present disclosure, the first communication signal 510 is a WU signal.

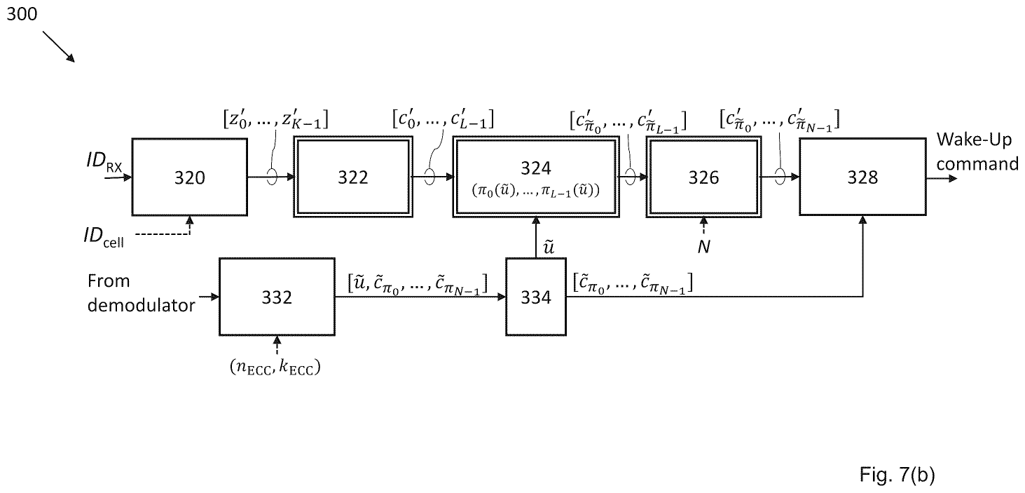

The WUS transmissions may be organized in frames as shown in FIG. 6. Each WU frame may consist of a synchronization preamble followed by a number T of WU slots. The WU frame may be transmitted in a predefined time-frequency resource which is shared by all UEs, i.e., all UEs may expect to receive their own WUS in that resource. FIG. 6 shows a WU frame wherein the WUSs for different UEs are Time-Division Multiplexed (TDM). However, other conventional multiplexing methods, for example Code Division Multiplexing (CDM), can be used in this respect. The synchronization preamble provides to the WURs a common timing reference. After preamble transmission, the transmitter device 100 sends a sequence of WUS, where each WUS consists of a codeword selected from a given error correction code (ECC) according to what in the following will be denoted a first embodiment and a second embodiment. The ECC codeword is further modulated according to a conventional modulation scheme and transmitted in a WU slot. The ECC codeword selection in the transmitter device 100, as well as the corresponding receiver device 300 processing, is based on the UE ID and on a sequence of pseudo-random integers u_{τ}, τ=0, . . . , T−1.

The first embodiment and the second embodiment describe solutions for ECC codeword selection and for providing the same pseudo-random integers sequence in the transmitter device 100 and all receiver devices 300. In order to simplify the mathematical notations, the slot index τ will be dropped in the subsequent descriptions and temporarily reintroduced when needed.

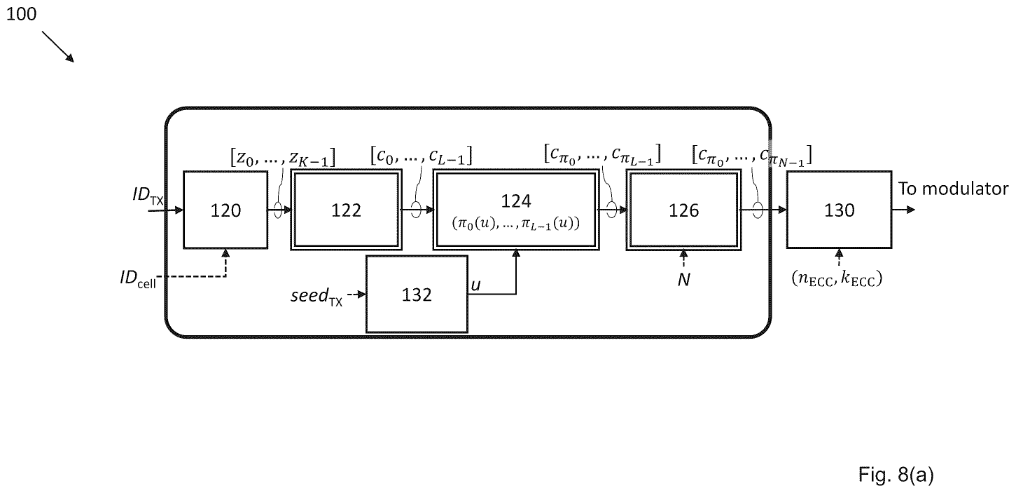

FIG. 7(a) shows a block scheme of the WUS transmitter device 100 according to the first embodiment wherein the ID of the UE to be woken up, denoted as ID_{TX} and having length B bits, is mapped to an ID string by a dynamic encoder with rate greater than 1, where the ID code rate is the length of ID_{TX} over the ID string length. Thus, rate greater than 1 implies that the ID string is shorter than ID_{TX}. Moreover, the encoder is dynamic as the mapping of ID_{TX} to ID string changes based on a pseudo-random integer that is generated in the transmitter device 100 in each WU slot and sent to the receiver devices 300 within the WUS.

The WUS transmitter device 100 divides the ID of B bits of the UE to be woken up, denoted as ID_{TX}, into a sequence of symbols z=[z₀, . . . , Z_{K-1}] in the bits-to-symbols block 120, where each symbol is obtained by map r bits to a symbol in GF(Q), where Q is any prime number or prime power. The values Q, K and r are predetermined and known by transmitter device 100 and the receiver device 300; any set of values satisfies the following inequalities can be used:

$$B \leq Kr , Q \geq {2}^{r} .$$

where B is the length in bits of ID_{TX}.

The obtained sequence of symbols z=[z₀, . . . , Z_{K-1}] is encoded by the ID encoder block 122 so as to generate a corresponding ID codeword comprising a sequence of symbols c=[c₀, . . . , C_{L-1}] where the symbols are from GF(Q) which large symbol distance.

A random generator block 132 produces a random integer u which is used to generate a random permutation π(u)=(π₀(u), . . . , π_{L-1} (u)). Based on the permutation π(u), a random interleaver block 124 produces the interleaved ID codeword c_{π}=[c_{π}_{₀}, . . . , c_{π}_{_{L−1}}]. A rate-matching block 126 selects N symbols from the interleaved ID codeword according to a predefined pattern so as to obtain a compressed ID word and forwards it to the concatenation block 128. For example, the rate matching block 126 may select the initial N symbols of its input sequence, thereby producing in its output a compressed ID word [c_{π}_{₀}, . . . , c_{π}_{_{N−1}}]. The random integer u and the compressed ID word are concatenated in the concatenation block X so as to produce the ID string [u, c_{π}_{₀}, . . . , c_{π}_{_{N−1}}]. An ECC codeword is selected in an EEC encoder block 130 for transmission based on the ID string. Finally, the ECC codeword is modulated and mapped to a set of time-frequency resources in a WU slot and transmitted as a first communication signal 510 to one or more receiver devices 300.

FIG. 7(b) shows a block scheme of the receiver device 300 according to the first embodiment. The WUS receiver device 300 divides the receiver UE ID, denoted as ID_{RX}, into a sequence of words of length r bits, and maps each word to a symbol of GF(Q) in a bits-to-symbol block 320. The obtained sequence

$$[ {z}_{0}^{′} , … , {z}_{K - 1}^{′} ]$$

is encoded by an ID encoder block 322 so as to generate a corresponding ID codeword

$$[ {c}_{0}^{′} , … , {c}_{L - 1}^{′} ] .$$

The received first communication signal 510 from a demodulator is decoded by an ECC decoder block 332, so as to produce a decoded ID string [ũ, \tilde{c}_{π}_{₀}, . . . , \tilde{c}_{π}_{_{N−1}}]. Symbols with the tilde sign on top denote corrupted versions of corresponding transmitter signals. From the decoded ID string, a splitter block 334 obtains a received random integer u and a received interleaved and rate-matched ID codeword [\tilde{c}_{π}_{₀}, . . . , \tilde{c}_{π}_{_{N−1}}]. The received random integer ũ is used to generate a random permutation π_{L}(ũ)=(π₀(ũ), . . . , π_{L-1}(ũ)). Based on the permutation π_{L}(ũ), a random interleaver block 324 produces the interleaved ID codeword

$$[ {c}_{{π}_{0}}^{′} , … , {c}_{{π}_{L - 1}}^{′} ] .$$

A rate-matching block 326 selects N symbols from the interleaved ID codeword according to a predefined pattern and forwards them to a comparator block 328. For example, the rate matching block 326 may select the initial N symbols of its input sequence, thereby producing in its output a received compressed ID word [\tilde{c}_{π}_{₀}, . . . , \tilde{c}_{π}_{_{N−1}}]. Finally, compressed ID words [\tilde{c}_{π}_{₀}, . . . , \tilde{c}_{π}_{_{N−1}} ] in the first communication signal 510 and compressed ID words

$$[ {c}_{{π}_{0}}^{′} , … , {c}_{{π}_{N - 1}}^{′} ]$$

generated by the WUS receiver device 300 are compared and a wake-up command for the main transceiver is generated if the comparison is successful, i.e. if they are the same.

The first embodiment addresses the first major drawback of conventional solutions by providing improved FA probability. The transmission method of the first embodiment has the following FA probability:

$${p}_{FA} = {\prod }_{i = 0}^{N - 1} P ( {\tilde{c}}_{{π}_{i}} = {c}_{{\tilde{π}}_{i}}^{′} ) = {2}^{- Nr} . \qquad ( 7 )$$

Equation (7) is obtained from Eq. (6) by substituting u with πᵢ and ũ with \tilde{π}ᵢ, thereby obtaining

$$P ( {\tilde{c}}_{{π}_{i}} = {c}_{{\tilde{π}}_{i}}^{′} ) = {2}^{- r} .$$

Therefore, the FA probability is exponentially smaller than conventional solutions: 2^{-Nr} compared to 2^{-r} of prior art from Eq. (6). A further advantage of the first embodiment is that, in the WUS transmitter device 100 and receiver device 300, the rate matching length N and the ECC codeword length can be selected so as to adapt the WUS transmission to the link quality, as will be explained in the following disclosure.

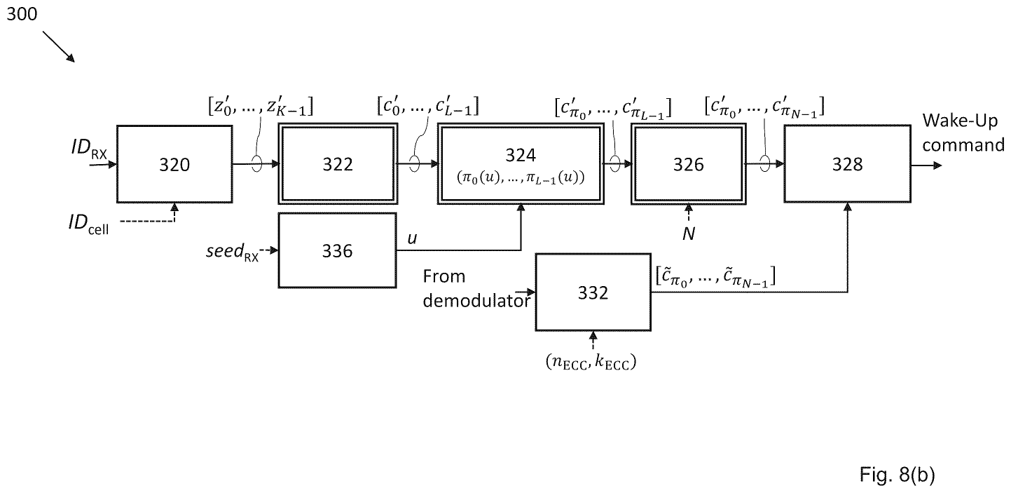

FIG. 8(a) and (b) instead shows the block schemes of a WUS transmitter device 100 and a WUS receiver device 300 according to the second embodiment. The processing blocks of the WUS transmitter device 100 and a WUS receiver device 300 are almost the same as in FIG. 7(a) and (b) but with the differences that in FIG. 8(a) the concatenation block 128 of FIG. 7(a) is absent, in FIG. 8(b) the splitting block 334 of FIG. 7(b) is absent, and the receiver device 300 of FIG. 8(b) is equipped with a pseudo-random number generator block 336, and the pseudo-random integer is obtained in the receiver device 300 from its own pseudo random generator block 336 instead of being obtained from the received first communication signal 510.

According to the second embodiment a pseudo-random integer is generated in each WU slot, by a random generator (RG) block 336 of the receiver device 300, thereby making transmission of the pseudo-random integer in each WUS of the first communication signal 510 no longer needed. The RG block in the transmitter device 100 and the RG block 336 in the receiver device 300 may maintain their synchronization by detecting the synchronization preamble in the WU frame, see FIG. 6. Thus, the final instant of each synchronization preamble may constitute a synchronization occasion for the WURs where they can initialize their own RG. RG initialization is done by setting an RG seed that was previously configured in the receiver device 300 by the transmitter device 100.

Compared to the first embodiment, the second embodiment produces shorter ID string, i.e., the subset of interleaved symbols, as there is no longer need to transmit the pseudo-random integer. The shorter ID string provides further improved performance compared to the first embodiment with lower FA probability, obtained by increasing the rate-matching length, i.e., larger N. Lower MD probability is also provided obtained by decreasing the ECC rate, that is, by generating more ECC parity bits. The second embodiment also has higher WUS transmission rate, obtained by shortening the WU slot.

### ID Encoder/Decoder Based on Galois Field Polynomials

According to a first ID encoder implementation option, the ID encoder maps the sequence z=[z₀, . . . , Z_{K-1}] to a codeword c=[c₀, . . . , c_{L-1}] according to a Galois Field polynomial (GFP) of degree K−1 or less over GF(Q), with Q a prime integer or prime power, so as to obtain a codeword of length L=Q. A GFP of degree K−1 over GF(Q) (coefficients) is defined (based on the ID) as follows:

$${c}_{i} = {\sum }_{j = 0}^{K - 1} {w}_{ID} ( j ) {i}^{j} , i = 0 , … , Q - 1 \qquad ( 8 )$$

where the coefficients W_{ID}(j), j=0, . . . , K−1, are elements of GF(Q). Thus, the second set of symbols is a codeword obtained according to a Galois field polynomial having a degree of at least K−1. Usage of GFPs is convenient for the following reason: it can be shown that any pair of codewords generated by GFPs of degree K−1 or less coincide in at most K−1coordinates—see Appendix 1 for a proof. A low number of coinciding coordinates produces a low FA probability, as the probability that two sequences generated by different IDs have same values in the same positions is at most (K−1)/Q.

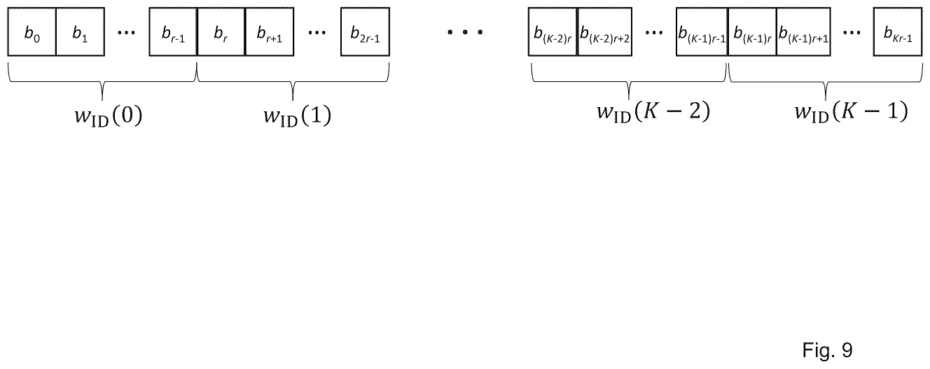

In the disclosed solution, the coefficients are determined based on the UE identity ID_{TX} and, optionally, also based on a physical cell identity ID_{cell}. For a given UE identity ID_{TX}, denoted by the bit sequence (b₀, b₁, . . . , b_{B-1}), the ID encoder selects a prime Galois field order Q, determines a word length r=[log₂ Q] and a polynomial degree K−1 such that K=[B/r]. The ID encoder maps ID_{TX} to the coefficients W_{ID}(j), j=0,1, . . . , K−1 as illustrated in FIG. 9.

As shown in FIG. 9, ID_{TX} is divided into a number K of r-bit words. The value of the degree-j coefficient is obtained based on the j^{th} word (bⱼᵣ, . . . , b₍ⱼ₊₁₎ᵣ₋₁) as follows:

$${W}_{ID} ( j ) = {\sum }_{u = 0}^{r - 1} {b}_{jr + u} {2}^{u} + {ϕ}_{j} , j = 0 , … , K - 1 , \qquad ( 9 )$$

In Eq. (9), the symbols ϕ₀, . . . , ϕ_{K-1} denote integers that take arbitrary values between 0 and Q−2^{r}; in this way, the right-hand side of Eq. (9) never exceeds Q−1, which is the maximum value a coefficient can take. In a possible variant of this implementation, the integers ϕ₀, . . . , ϕ_{K-1} are all zeros “0”. In another variant the ϕ₀, . . . , ϕ_{K-2} are all zeros and ϕ_{K-1}=1 so as to guarantee that the Galois field polynomial (7) has degree K−1.

According to an option of this ID encoder implementation, the integers ϕ₀, . . . , ϕ_{K-1} are determined based on the cell identity ID_{cell}. The cell identity is divided into K words of length r′=[log₂(Q−2¹+1)], and mapped to ϕ₀, . . . , ϕ_{K-1} as follows:

$${ϕ}_{j} = {\sum }_{u = 0}^{{r}^{′} - 1} {[ {ID}_{cell} ]}_{j {r}^{′} + u} {2}^{u} , j = 0 , … , K - 1. \qquad ( 10 )$$

where [ID_{cell}]ᵤ denotes the u^{th} bit in the binary representation of ID_{cell}. The cell identity ID_{cell} may coincide with the physical-layer cell identity

$${N}_{ID}^{cell}$$

### of 3GPP TS 36.211 V16.6.0 (2021-06), Sec. 7.4.2.

### ID Encoder/Decoder Based on Reed-Solomon Codes

According to a second ID encoder implementation option, the ID encoder maps the sequence z=[z₀, . . . , Z_{K-1}] to a codeword c=[c₀, . . . , c_{L-1}] of a (L, K) Reed-Solomon code over GF(Q), where Q is a prime integer or a prime power such that Q≥2^{r}. Thus, the second set of symbols forms a codeword of a Reed-Solomon code according to this embodiment.

### Interleaver and Rate-Matching

As previously mentioned, the interleaver block rearranges the input sequence according to an arbitrary permutation that is generated according to a random number u. Its purpose is to allow selection of an arbitrary subset of symbols. In a possible implementation, the permutation can be a cyclic shift, defined as follows:

$${π}_{i} = u + i ( mod L ) \qquad ( 11 )$$

Equation (11) is a special case of permutation polynomial where at least one of its coefficients depend on u.

By the above permutation, the input sequence is [c₀, . . . , c_{L-1}] is transformed into [cᵤ, . . . , c_{L-1}, c₀, . . . , cᵤ₋₁].

The rate-matching block selects a number of symbols N from arbitrary positions in its input sequence and forwards them to the next processing block. Therefore, the transmitter device 100 may select the subset of interleaved symbols based on a predefined selection rule. In a possible implementation, rate matching selects the initial N symbols from its input sequence [cᵤ, . . . , c_{L-1}, c₀, . . . , cᵤ₋₁] so as to produce in its output the sequence [cᵤ, . . . , c_{u+N-1 (mod L)}]. In another possible implementation, rate matching selects the N last symbols of the set of interleaved symbols. The predefined selection rule is also applicable for the receiver device 300.

### Error Correction Code

The WUR is an ultra-low power system with limited energy availability. Therefore, the error correction code must allow simple decoder implementation. In general, a binary error correction code is described by the following three parameters (n_{ECC}, k_{ECC}, t_{ECC}) in bits, where n_{ECC} is the codeword length, k_{ECC} the ID string length and t_{ECC} its error correction capability. k_{ECC} is the length of the ID string, that is k_{ECC}=N[log₂ Q]+[log₂ L] for the first embodiment, k_{ECC}=N[log₂ Q] for the second embodiment.

According to a 1^{st} ECC implementation option, the ECC is a Bose-Chaudhuri-Hocquenghem (BCH) binary systematic code with parameters (n_{ECC}, k_{ECC}, t_{ECC}) obtained by shortening a “mother” BCH code with parameters (n_{ECC}+s,k_{ECC}+s,t_{ECC}). Shortening is done by appending s zero bits to the ID string so as to obtain a (k_{ECC}+S)-bit word, by encoding the word so as to obtain a corresponding (n_{ECC}+s)-bit codeword, then finally removing the s zero bits from the systematic part of the codeword so as to obtain a shortened n_{ECC}-bit codeword.

According to a 2^{nd} ECC implementation option, the ECC is an Orthogonal Latin Square Code (OLSC). OLSCs allow error correction based on simple majority logic decoding circuits. OLSC exist for any information word length k=m² bits and codeword length n=k+2tm bits, where m is an arbitrary positive integer, and t is the error correction capability. OLS codes are systematic codes and therefore can be shortened in the same way as described above for BCH codes.

### Random Generators

In a first RG implementation option, the RG is a linear congruential generator. Linear congruential generators are described by the following equation:

$${seed}_{τ + 1} = {h}_{1} + {h}_{2} {seed}_{τ} ( mod {2}^{D} ) , τ = 0 … , T - 2 \qquad ( 12 )$$

where τ is the time index, i.e., the WU slot index within a WU frame, and D is the number of bits of the bit register that is used to store the seed. The initial RG seed, i.e., the input to generate the random integer seed₀, can be any non-zero integer number.

Thus, according to a possible option of the 1^{st} RG implementation, the initial seed may be

$${seed}_{0} = {N}_{ID}^{cell} + 1 , where {N}_{ID}^{cell}$$

is the physical-layer cell identity specified in 3GPP TS 38.211 V16.6.0 (2021-06), Sec. 7.4.2. The random integer uₜ may therefore be obtained as follows:

$${u}_{τ} = {seed}_{τ} ( mod L ) , τ = 0 … , T - 1. \qquad ( 13 )$$

In a second RG implementation option, the random integer uₜ is derived from a NR pseudo-random sequence c(n), n=0, . . . , M_{PN}−1, for a given sequence length M_{PN}, where c(n) is a length-31 Gold sequence as specified in 3GPP TS 38.211 V16.6.0 (2021-06), Sec. 5.2.1.

According to a possible option of the 2^{nd} RG implementation, the Gold sequence generator initialization value cᵢₙᵢₜ may be set as

$${c}_{init} = {N}_{ID}^{cell} .$$

For an arbitrary integer Q≥log₂ L, the τ^{th} Q-bit word of the above sequence may be used to generate a random integer u_{τ} as follows:

$${u}_{τ} = {\sum }_{q = 0}^{Q - 1} c ( τ Q + q ) {2}^{q} ( mod L ) , τ = 0 … , T - 1. \qquad ( 14 )$$

### Signaling Aspects

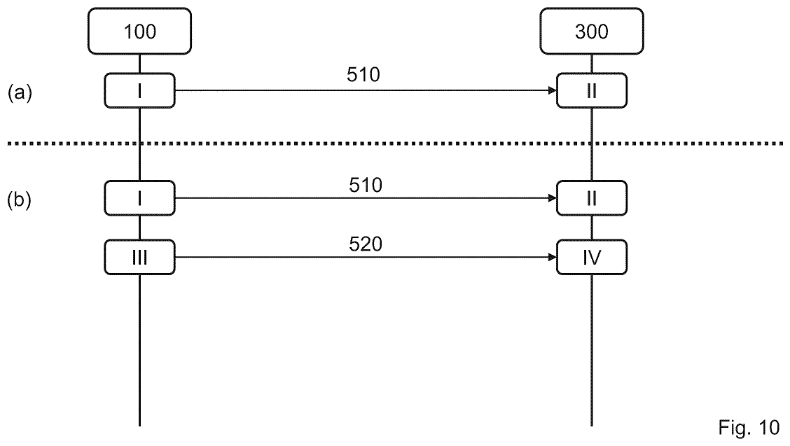

FIG. 10 illustrates two main signaling aspects corresponding to the previously mentioned first and second embodiments where FIG. 10(a) shows the signaling for the first embodiment and FIG. 10(b) shows the signaling for the second embodiment.

In FIG. 10(a) the transmitter device 100 transmits a first communication signal 510 indicating the compressed ID of the receiver device 300. The first communication signal 510 also indicates the pseudo-random integer. Thereby, the receiver device 300 may derive the pseudo-random integer directly from the first communication signal 510 so as to interleave the second set of symbols based on the pseudo-random integer.

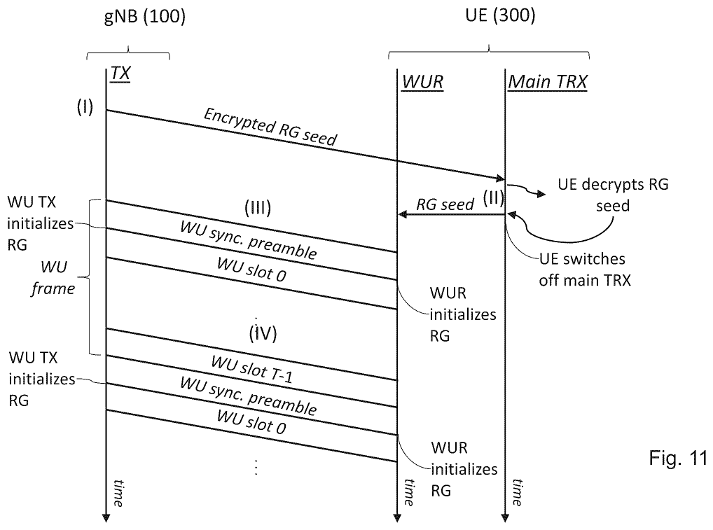

In FIG. 10(b) the transmitter device 100 as in FIG. 10(a) transmits a first communication signal 510 indicating the compressed ID of the receiver device 300. However, the transmitter device 100 also transmits a separate second communication signal 520 indicating an initial seed for computing the pseudo-random integer as previously discussed. FIG. 11 shows more in detail how the seed distribution may be performed in the communication system 500 according to the second embodiment.

The RG seed distribution and initialization procedure which is relevant for the second embodiment is illustrated in FIG. 11. The seed distribution may be performed through an encrypted channel such as an encrypted physical downlink shared channel (PDSCH). In that way, the seed can't be eavesdropped. A potential attacker who is attempting to generate a counterfeit WUS signal would have to guess the RG seed by observing the transmitted WUS. Guessing the seed of an RG requires the observation of a long portion of the RG output sequence or even a whole period of the (typically very long) RG sequence. Here, the WUS transmitter may only use short subsequences of the whole RG sequence; moreover, the RG sequence is not transmitted in clear within the WUS. Thus, RG seed guessing is practically impossible. This addresses another major shortcoming of conventional solutions-vulnerability to spoofing attacks. Encrypted seed distribution is done through the UE's main TRX. Before switching off the UE's main TRX, the gNB sends an encrypted seed. The UE decrypts the seed and stores it in its WUR, then goes to sleep.

In step I in FIG. 11, the transmitter device 100 sends a random number generator (RG) initial seed to the receiving device 300 through an encrypted channel.

In step II in FIG. 11, the receiver device 300 decrypts the RG initial seed and configures that initial seed in the WUR.

In step III in FIG. 11, the transmitter device 100 transmits a WUS synchronization preamble to the receiver device 300. The WUR of the receiver device 300 detects the WUS synchronization preamble and simultaneously initializes its own RG using the previously configured initial seed.

In step IV in FIG. 11, the transmitter device 100 transmits a sequence of WUSs to one or more receiver devices, e.g., in a broadcast transmission. The WUR of the receiver device 300 detects the WUSs sequence based on the pseudo/random numbers generated by its own RG.

RGs initialization may be performed by setting the same initial seed in the transmitter device's RG immediately after transmission of the synchronization preamble, whereas the RGs in the receiver devices are initialized immediately after reception of the synchronization preamble—see FIG. 11. According to an alternative option, the RG initialization is done while the receiver device is using the main TRX, in which case it is still time synchronized with the transmitter device 100.

### Link Adaptation

As UEs as receiver devices 300 may be deployed in wide areas and therefore experience significantly different channel qualities, it may be convenient to configure the main WUS parameters in each transmission, i.e., N, k_{ECC} and n_{ECC}, according to an expected quality of the received signal. For a given ECC codeword length n_{ECC}, one can obtain different FA-MD performance trade-offs by configuring the rate matching length N and the ECC code parameters k_{ECC}, n_{ECC}. Large N produces low FA probability, as shown by Eq. (7). However, large N produces long ID strings, therefore there is less room for parity bits in the codeword, which results in a smaller error correction capability and ultimately in a worse MD performance. On the other hand, small N produces worse FA performance, but better MD performance. Therefore, for a low-SNR UE at the cell edge, it might be convenient to configure the ECC to have a high error correction capability, thereby producing a sufficiently low MD probability; on the other hand, for a high-SNR UE near the cell center, an acceptable MD probability might be obtained with a lower ECC error correction capability, which would be obtained with less ECC parity check bits and thus would leave room for transmission of more interleaved symbols, that is, larger N, thereby a lower FA probability.

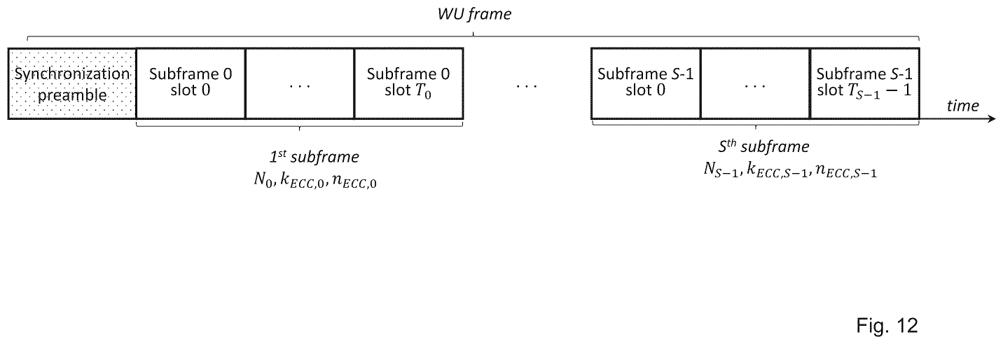

As there is no control channel by which a transmitter device 100 could provide dynamic WUS parameter indication to the receiver devices 300, in a possible implementation option of the above embodiments the WU frame of FIG. 6 is divided into a number S of subframes of given numbers of slots (T₀, . . . , T_{S-1}), and each subframe is associated with a WUS parameter configuration (Nₛ, k_{ECC,s}, n_{ECC,s}), S=0, . . . , S−1. The number of subframes S, the durations (T₀, . . . , T_{S-1}), and the WUS parameters for each subframe (Nₛ, k_{ECC,s}, n_{ECC,s}) may be based on semi-static configuration by higher layers. FIG. 12 illustrates a possible WUS parameter configuration in a WU frame.

### Performance Evaluation

Performance evaluations have been carried out in order to evaluate the MD and FA probabilities. The following two options have been evaluated:
1. Option 1. First embodiment, ID encoder is RS(63,8) over GF(2⁶), rate matching length N=2, ECC is a BCH(63,36,5) shortened by 18 bits so as to obtain a BCH(45,18,5) code; and
2. Option 2. Second embodiment, ID encoder is GFP(67,8) over GF(67), rate matching length N=2, ECC is a BCH(63,30,6) shortened by 16 bits so as to obtain a BCH(47,14,6) code.

The random generator is a linear congruential generator with h₁=1013904223, h₂=1664525 and D=16. The RG produces random numbers u96 between 0 and L−1. Based on the random number u_{τ}, the permutation for the τ^{th} WU slot is obtained as follows:

$${π}_{i} ( τ ) = {u}_{τ} + i ( mod L ) , i = 0 , … , L - 1. \qquad ( 15 )$$

The modulation is 2OOK. The channel is Additive White Gaussian Noise (AWGN) with SNR=E_{S}/N₀, where E_{S} is the average modulation symbol energy and N₀ is the one-sided power spectral density of white noise. The main performance evaluation parameters are summarized in Table 1.

TABLE 1
Performance evaluation parameters.

| | Prior art | Eval. | Eval. |
|---|---|---|---|
| Parameter/feature | [4] | option 1 | option 2 |
| Embodiment | Not | 1 | 2 |
| | applicable | | |
| ID length B [bits] | 48 | 48 | 48 |
| Word length r [bits] | 8 | 6 | 6 |
| ID code (L, K) and field | RS(255, 6), | RS(63, 8), | GFP(67, 8), |
| | GF(2⁸) | GF(2⁶) | GF(67) |
| Rate-matching length N [symb.] | 1 | 2 | 2 |
| Ident. string length n [bits] | 16 | 18 | 14 |
| Transmission code | BCH(49, | BCH(45, | BCH(47, |
| (n_{ECC}, k_{ECC}, t_{ECC}) | 16, 6) | 18, 5) | 14, 6) |
| TX signal length [symbols] | 49 | 45 | 47 |
| Modulation | 2OOK | 2OOK | 2OOK |
| Channel model | AWGN | AWGN | AWGN |
| Number of UEs | 1024 | 1024 | 1024 |

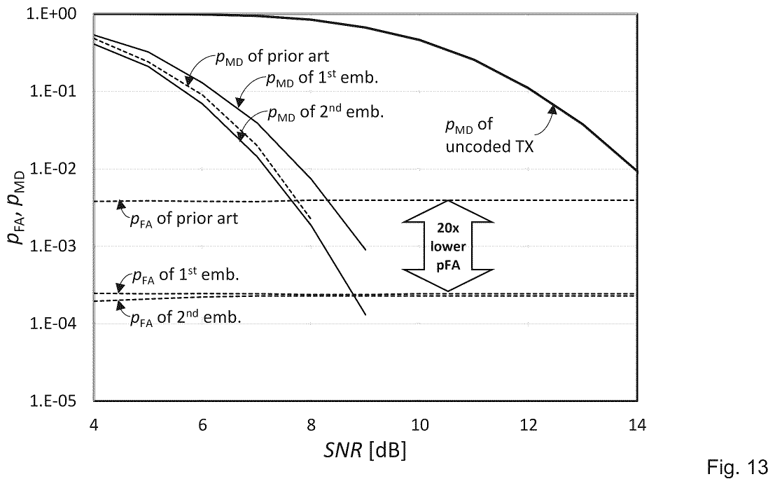

The performance evaluation results are shown in FIG. 13. For p_{MD}=10⁻³, the proposed solution has SNR gain of approximately 4 dB compared to uncoded transmission; all the above options have roughly the same MD performance. We also observe that the probability of FA is fairly well predicted by Eq. (11) at high SNR. At low SNR, the false-alarm performance of the GFP solution (Eval. option 1 in Table 1) is slightly better than the RS solution (Eval. option 2 in Table 1).

The transmitter device 100 herein may also be denoted as a network access node or a client device. The receiver device 300 herein may also be denoted as a network access node or a client device.

A network access node herein may also be denoted as a radio network access node, an access network access node, an access point (AP), or a base station (BS), e.g., a radio base station (RBS), which in some networks may be referred to as transmitter, “gNB”, “gNodeB”, “eNB”, “eNodeB”, “NodeB” or “B node”, depending on the standard, technology and terminology used. The radio network access node may be of different classes or types such as e.g., macro eNodeB, home eNodeB or pico base station, based on transmission power and thereby the cell size. The radio network access node may further be a station, which is any device that contains an IEEE 802.11-conformant media access control (MAC) and physical layer (PHY) interface to the wireless medium (WM). The radio network access node may be configured for communication in 3GPP related long term evolution (LTE), LTE-advanced, fifth generation (5G) wireless systems, such as new radio (NR) and their evolutions, as well as in IEEE related Wi-Fi, worldwide interoperability for microwave access (WiMAX) and their evolutions.

A client device herein may be denoted as a user device, a user equipment (UE), a mobile station, an internet of things (IoT) device, a sensor device, a wireless terminal and/or a mobile terminal, and is enabled to communicate wirelessly in a wireless communication system, sometimes also referred to as a cellular radio system. The UEs may further be referred to as mobile telephones, cellular telephones, computer tablets or laptops with wireless capability. The UEs in this context may be, for example, portable, pocket-storable, hand-held, computer-comprised, or vehicle-mounted mobile devices, enabled to communicate voice and/or data, via a radio access network (RAN), with another communication entity, such as another receiver or a server. The UE may further be a station, which is any device that contains an IEEE 802.11-conformant MAC and PHY interface to the WM. The UE may be configured for communication in 3GPP related LTE, LTE-advanced, 5G wireless systems, such as NR, and their evolutions, as well as in IEEE related Wi-Fi, WiMAX and their evolutions.

Furthermore, any method according to embodiments of the present disclosure may be implemented in a computer program, having code means, which when run by processing means causes the processing means to execute the steps of the method. The computer program is included in a computer readable medium of a computer program product. The computer readable medium may comprise essentially any memory, such as previously mentioned a ROM, a PROM, an EPROM, a flash memory, an EEPROM, or a hard disk drive.

Moreover, it should be realized that the transmitter device and the receiver device comprise the communication capabilities in the form of e.g., functions, means, units, elements, etc., for performing or implementing embodiments of the present disclosure. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, TCM encoder, TCM decoder, power supply units, power feeders, communication interfaces, communication protocols, etc. which are suitably arranged together for performing the solution.

Therefore, the processor(s) of the transmitter device and the receiver device may comprise, e.g., one or more instances of a CPU, a processing unit, a processing circuit, a processor, an ASIC, a microprocessor, or other processing logic that may interpret and execute instructions. The expression “processor” may thus represent a processing circuitry comprising a plurality of processing circuits, such as e.g., any, some or all of the ones mentioned above. The processing circuitry may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

### Appendix

A first Galois field polynomial of degree K−1 with coefficients in GF(Q), where Q is a prime or prime power, is defined as follows:

$${p}_{1} ( i ) = {\sum }_{j = 0}^{K - 1} {w}_{1} ( j ) {i}^{j} , i = 0 , … , Q - 1. \qquad ( 16 )$$

A second Galois field polynomial of degree K−1 over GF(Q) is defined as follows:

$${p}_{2} ( i ) = {\sum }_{j = 0}^{K - 1} {w}_{2} ( j ) {i}^{j} , i = 0 , … , Q - 1. \qquad ( 17 )$$

Assume that the two above polynomials coincide at R values of i, that is, for i∈{i₁, i₂, . . . , i_{R}}. We have

$$q ( i ) = {p}_{1} ( i ) - {p}_{2} ( i ) = 0 , i ∈ \{ {i}_{1} , {i}_{2} , … , {i}_{R} \} \qquad ( 18 )$$

It means that the following polynomial

$$q ( i ) = {\sum }_{j = 0}^{K - 1} ( {w}_{1} ( j ) - {w}_{2} ( j ) ) {i}^{j} , i ∈ \{ {i}_{1} , {i}_{2} , … , {i}_{R} \} . \qquad ( 19 )$$

has {i₁, i₂, . . . , i_{R}} as its roots. Since any polynomial of degree K−1 with coefficients in GF(Q) has at most K−1 roots in GF(Q), then R≤K−1.

What is claimed is:

1. A transmitter device for a communication system, the transmitter device comprising a processor, and a memory coupled to the processor and having processor-executable instructions stored thereon, wherein the processor is configured to execute the processor-executable instructions to facilitate the transmitter device to:
divide a set of bits representing an identity of a receiver device into a first set of symbols comprising K number of symbols belonging to a Galois field, wherein K is a positive integer;
map the first set of symbols based on an error correction code to obtain a second set of symbols belonging to the Galois field;
interleave the second set of symbols based on a pseudo-random integer to obtain a set of interleaved symbols;
select a subset of interleaved symbols among the set of interleaved symbols, the subset of interleaved symbols representing a compressed identity of the receiver device and comprising N number of symbols, wherein N is a positive integer and N is less than K; and
transmit a first communication signal to the receiver device, the first communication signal indicating the subset of interleaved symbols.

2. The transmitter device according to claim 1, wherein the second set of symbols is a codeword obtained according to a Galois field polynomial having a degree of at least K-1.

3. The transmitter device according to claim 1, wherein the second set of symbols forms a codeword of a Reed-Solomon code.

4. The transmitter device according to claim 1, wherein the first communication signal further indicates the pseudo-random integer.

5. The transmitter device according to claim 1, wherein the pseudo-random integer is computed based on an initial seed and a linear congruential generator or a pseudo-random Gold sequence generator.

6. The transmitter device according to claim 5, wherein the processor is further configured to execute the processor-executable instructions to facilitate the transmitter device to:
transmit a second communication signal to the receiver device, wherein the second communication signal indicates the initial seed for computing the pseudo-random integer.

7. The transmitter device according to claim 6, wherein the second communication signal is transmitted over an encrypted communication channel.

8. The transmitter device according to claim 1, configured to:
select the subset of interleaved symbols based on a predefined selection rule.

9. The transmitter device according to claim 8, wherein the predefined selection rule indicates any of: selecting the N first symbols or the N last symbols of the set of interleaved symbols.

10. The transmitter device according to claim 1, wherein the first communication signal is a wake-up signal.

11. A receiver device for a communication system, the receiver device comprising a processor, and a memory coupled to the processor and having processor-executable instructions stored thereon, wherein the processor is configured to execute the processor-executable instructions to facilitate the receiver device to:
receive a first communication signal from a transmitter device, wherein the first communication signal indicates a first subset of interleaved symbols representing a first compressed identity of the receiver device;
divide a set of bits representing an identity of a receiver device into a first set of symbols comprising K number of symbols belonging to a Galois field, wherein K is a positive integer;
map the first set of symbols based on an error correction code to obtain a second set of symbols belonging to the Galois field;
interleave the second set of symbols based on a pseudo-random integer to obtain a set of interleaved symbols;
select a second subset of interleaved symbols among the set of interleaved symbols, wherein the second subset of interleaved symbols represents a second compressed identity of the receiver device and comprises N number of symbols, wherein N is a positive integer and N is less than K; and
generate a wake-up command based on the first subset of interleaved symbols and second subset of interleaved symbols being the same.

12. The receiver device according to claim 11, wherein the second set of symbols is a codeword obtained according to a Galois field polynomial having a degree of at least K-1.

13. The receiver device according to claim 11, wherein the second set of symbols forms a codeword of a Reed-Solomon code.

14. The receiver device according to claim 11, wherein the first communication signal further indicates the pseudo-random integer.

15. The receiver device according to claim 11, wherein the processor is further configured to execute the processor-executable instructions to facilitate the receiver device to:
receive a second communication signal from the transmitter device, wherein the second communication signal indicates an initial seed for computing the pseudo-random integer; and
compute the pseudo-random integer based on the initial seed.

16. The receiver device according to claim 15, wherein the pseudo-random integer is computed based on the initial seed and a linear congruential generator or a pseudo-random Gold sequence generator.

17. The receiver device according to claim 15, wherein the second communication signal is received over an encrypted communication channel.

18. The receiver device according to claim 11, wherein the processor is further configured to execute the processor-executable instructions to facilitate the receiver device to:
select the second subset of interleaved symbols based on a predefined selection rule.

19. The receiver device according to claim 18. wherein the predefined selection rule indicates any of: selecting the N first symbols or the N last symbols of the set of interleaved symbols.

20. The receiver device according to claim 11. wherein the first communication signal is a wake-up signal.
